(19) United States
(12) Patent Application Publication
(10) Pub. No.: US 2024/0079739 A1
(43) Pub. Date: Mar. 7, 2024

(54) FLEXIBLE ELECTRICAL CONNECTION SYSTEM AND METHOD FOR FLEXIBLY ELECTRICALLY CONNECTING

(71) Applicant: Ford Global Technologies, LLC, Dearborn, MI (US)

(72) Inventors: Caleb Wang, Canton, MI (US); Patrick Daniel Maguire, Ann Arbor, MI (US); Jerry Lan, Ann Arbor, MI (US)

(21) Appl. No.: 18/164,435

(22) Filed: Feb. 3, 2023

Related U.S. Application Data
(60) Provisional application No. 63/403,445, filed on Sep. 2, 2022.

(51) Int. Cl. H01M 50/552; H01M 50/567

(52) U.S. Cl. CPC H01M 50/552; H01M 50/567

(57) ABSTRACT

An electrical connection system includes a first electrical contact, and a second electrical contact joined directly to the first electrical contact. The first electrical contact is configured to flex relative to the second electrical contact along a first axis, and configured to flex relative to the first electrical contact along a second axis.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to electrical connections of a traction battery pack.

### BACKGROUND

A traction battery pack of an electrified vehicle can include groups of battery cells arranged in one or more cell stacks. The traction battery pack can include electrical connection systems that connect components of the traction battery pack. Electrical connection systems can also be used to connect components of the traction battery pack to components outside the traction battery pack.

### SUMMARY

In some aspects, the techniques described herein relate to an electrical connection system, including: a first electrical contact; and a second electrical contact joined directly to the first electrical contact, the first electrical contact configured to flex relative to the second electrical contact along a first axis, and configured to flex relative to the first electrical contact along a second axis.

In some aspects, the techniques described herein relate to an electrical connection system, wherein the first electrical contact is a first busbar electrically connected to first battery terminal of a first battery, and the second electrical contact is a second busbar electrically connected to a second battery terminal of a different, second battery.

In some aspects, the techniques described herein relate to an electrical connection system, wherein the first battery is within a first cell stack and the second battery is within a different, second cell stack.

In some aspects, the techniques described herein relate to an electrical connection system, wherein a portion of the first battery terminal is disposed within a case of the first battery, and a portion of the second battery terminal is disposed within a case of the second battery.

In some aspects, the techniques described herein relate to an electrical connection system, wherein the first electrical contact includes more bends than the second electrical contact.

In some aspects, the techniques described herein relate to an electrical connection system, wherein the first electrical contact includes a plurality of bends, and the second electrical contact includes no more than one bend.

In some aspects, the techniques described herein relate to an electrical connection system, further including a mechanical fastener that joins the second electrical contact directly to the first electrical contact, wherein the mechanical fastener is received within both a first aperture of the first electrical contact and within a second aperture of the second electrical contact.

In some aspects, the techniques described herein relate to an electrical connection system, wherein at least one of the first aperture or the second aperture is oval-shaped.

In some aspects, the techniques described herein relate to an electrical connection system, wherein the first electrical contact and the second electrical contact are within a traction battery pack.

In some aspects, the techniques described herein relate to an electrical connection system, wherein the first electrical contact is flexible relative to the second electrical contact.

In some aspects, the techniques described herein relate to an electrical connection system, wherein the second electrical contact is rigid relative to the first electrical contact.

In some aspects, the techniques described herein relate to an electrical connection system, wherein the first electrical contact is a flexible first electrical contact, and the second electrical contact is a rigid second electrical contact.

In some aspects, the techniques described herein relate to an electrical connection system, wherein the first electrical contact is configured to flex back-and-forth vertically and to flex back-and-forth horizontally.

In some aspects, the techniques described herein relate to an electrical connection system, wherein the first electrical contact is a first busbar, and the second electrical contact is a second busbar.

In some aspects, the techniques described herein relate to a method of electrically connecting components, including: joining a first electrical contact to a second electrical contact; and flexing at least one of the first electrical contact or the second electrical contact during the joining.

In some aspects, the techniques described herein relate to a method, further including joining the first electrical contact to the second electrical contact with a mechanical fastener.

In some aspects, the techniques described herein relate to a method, wherein the flexing includes flexing vertically and flexing horizontally.

In some aspects, the techniques described herein relate to a method, wherein the first electrical contact is flexible relative to the second electrical contact.

In some aspects, the techniques described herein relate to a method, wherein the first electrical contact is a first busbar joined directly to a first terminal of a first battery, and the second electrical contact is a second busbar joined directly to a second terminal of a second battery.

In some aspects, the techniques described herein relate to a method, wherein the first battery is within a first cell stack of a traction battery pack, and the second battery is within a second cell stack of the traction battery pack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates a battery cell from the battery pack of FIG. 2.

FIG. 4 illustrates an exemplary embodiment of an electrical connection system at area 1 in FIG. 2 prior to joining a first electrical contact to a second electrical contact.

FIG. 5 illustrates a perspective view of the first electrical contact from the electrical connection system of FIG. 4.

FIG. 6 illustrates a perspective view of the second electrical contact from the electrical connection system of FIG. 4.

FIG. 7 illustrates the electrical connection system of FIG. 4 after joining the first electrical contact to the second electrical contact.

### DETAILED DESCRIPTION

This disclosure details exemplary electrical connection systems that electrically connect components within a traction battery pack. The electrical connections can adjust for component alignments, build tolerances, etc.

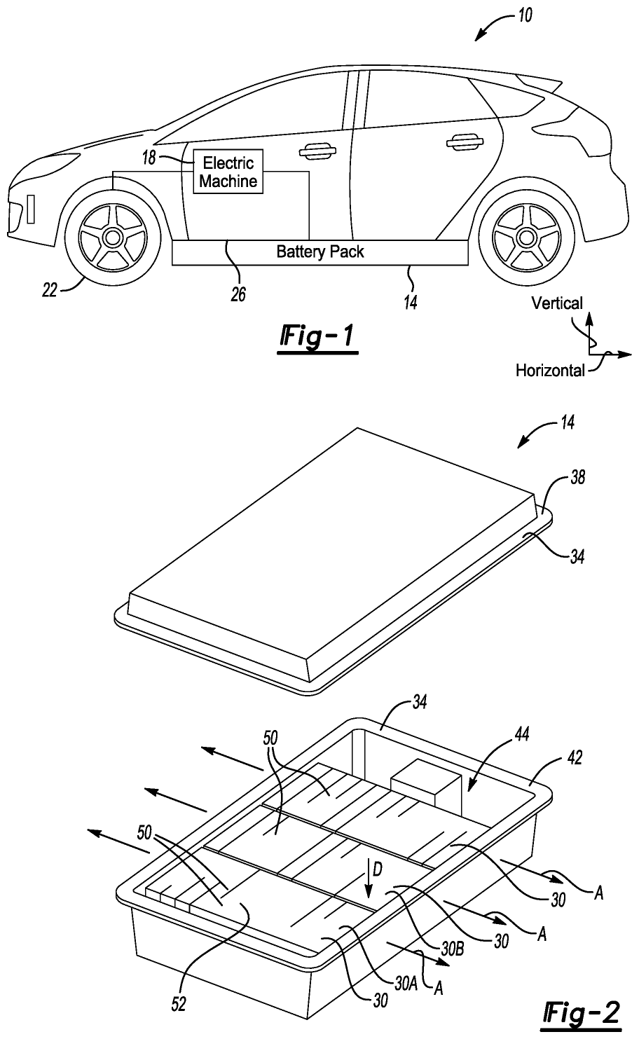

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

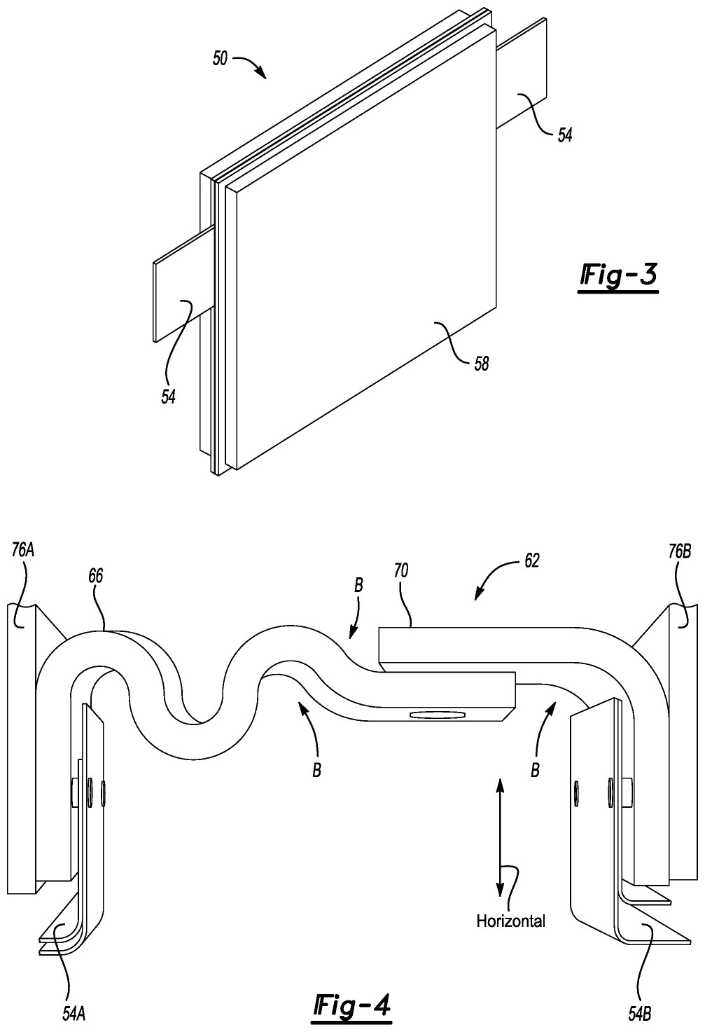

With reference now to FIGS. 2 and 3, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes, among other things, a plurality of battery cells 50 (or simply “cells”) stacked side-by-side relative to each along a respective cell stack axis A. In this example, the axes A of the cell stacks 30 and the cross-members 46 are parallel to each other and extend longitudinally in a cross-vehicle direction.

The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure.

Each of the example battery cells 50 includes a pair of tab terminals 54 extending from case 58. Within a given one of the cell stacks 30, the individual battery cells 50 can be electrically connected together. To provide these electrical connections, the tab terminals 54 of the battery cells 50 can be connected to the tab terminals 54 of other battery cells 50.

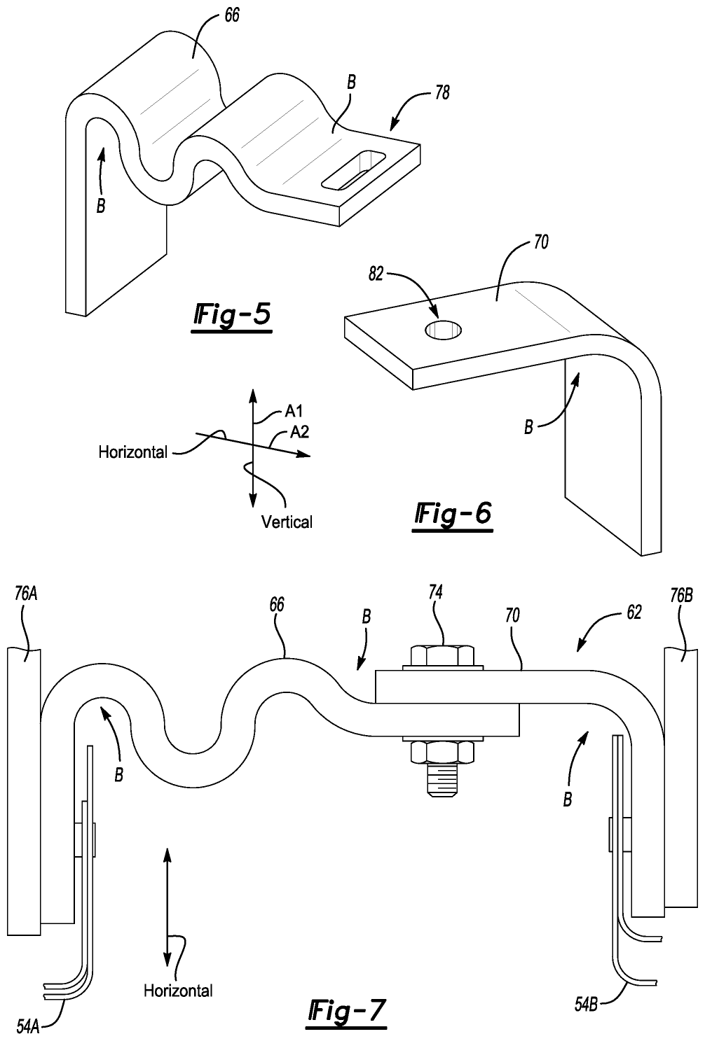

In this example, the battery pack 14 also electrically connects together the cell stacks 30. With reference to FIGS. 4-7 and continued reference to FIG. 2, a plurality of electrical connection systems 62 are included within the traction battery pack 14 to electrically connect together the cell stacks 30.

In other examples, the electrical connection systems 62 could be utilized to electrically connect the cell stacks 30 to other components of the traction battery 14 such as a busbar module. In still other examples, components other than cell stacks 30 are electrically connected together with the electrical connection system 62. The electrical connection systems 62 could be used to electrically connect together components outside the traction battery pack 14. Thus, although described as electrically connecting together cell stacks 30, the electrical connection systems 62 are not limited to electrically connecting together the cell stacks 30.

In the exemplary embodiment, the electrical connection systems 62 each include a first electrical contact 66 and a second electrical contact 70. FIG. 4 shows the electrical connection system 62 prior to joining the first electrical contact 66 to the second electrical contact 70. FIG. 7 shows the electrical connection system 62 after joining the first electrical contact 66 to the second electrical contact 70. The first electrical contact 66 is joined directly to the second electrical contact 70 in FIG. 7.

In this example, a threaded mechanical fastener 74, here a bolt and nut, joins the first electrical contact 66 to the second electrical contact 70. In other examples, another type of mechanical fastener could be used, or welds could be used to join the first electrical contact 66 to the second electrical contact 70.

In this example, the first electrical contact 66 is a first busbar electrically connected to at least one first battery terminal 54A of at least one first battery cell 50 within a first one of the cell stacks 30A, and the second electrical contact 70 is a second busbar electrically connected to at least one second battery terminal 54B of a different, second battery cell 50 within a second one of the cell stacks 30B. The first electrical contact 66 can be welded to the at least one first battery terminal 54A, and the second electrical contact 70 can be welded to the at least one second battery terminal. The first electrical contact 66 can be mounted on a cross-member 76A disposed along a side of the cell stack 30A. The second electrical contact 70 can be mounted on a cross-member 76B along a side of the cell stack 30B. The first electrical contact 66 and the second electrical contact 70 are each about three millimeters thick in this example.

At least a portion of the first battery terminals 54A are disposed within respective cases 58 of the at least one first battery cell 50A, and at least a portion of the second battery terminals 54B are disposed within respective cases 58 of the at least one second battery cell 50B.

In this example, the first electrical contact 66 includes a first aperture 78, and the second electrical contact includes a second aperture 82. The mechanical fastener is received within the first aperture 78 and the second aperture 82 when joining the first electrical contact 66 to the second electrical contact 70.

The first electrical contact 66 is typically joined to the second electrical contact 70 after positioning the first cell stack 30A and the second cell stack 30B into the enclosure assembly 34. Proper alignment of the first electrical contact 66 to the second electrical contact 70 can facilitate assembly of the first electrical contact 66 to the second electrical contact 70. Build variations, part tolerances, and other factors can lead to the first electrical contact 66 being slightly misaligned from the second electrical contact 70.

To accommodate misalignment, the first electrical contact 66, prior to being directly joined to the second electrical contact 70, is configured to flex relative to the first electrical contact 66 along at least a first axis A1, and configured to flex relative to the first electrical contact 66 along a second axis A2 transverse to the first axis A1. The flexibility of the first electrical contact 66 facilitates directly joining the first electrical contact 66 to the second electrical contact 70 as the first electrical contact 66 and the second electrical contact 70 can be repositioned relative to each other during the securing.

In this example, the flexibility of the first electrical contact 66 relative to the second electrical contact 70 is provided by the first electrical contact 66 having more bends than the second electrical contact 70. More specifically, in this example, first electrical contact 66 has a plurality of bends B, and the second electrical contact has a single bend B. The bends B of the first electrical contact 66 are between where the first electrical contact 66 is joined to the at least one first terminal 54A and where the first electrical contact 66 is secured to the second electrical contact 70. The bend B of the second electrical contact 70 is between where the second electrical contact 70 connects to the at least one second terminal 54B and where the second electrical contact 70 is secured to the first electrical contact 66.

In this example, the first electrical contact 66 is more flexible than the second electrical contact 70 because the first electrical contact 66 has more bends B than the second electrical contact 70. The first electrical contact 66 is thus considered a flexible electrical contact, and the second electrical contact 70 a rigid electrical contact. The bends B in the first electrical contact 66 facilitate flexing the first electrical contact 66 back-and-forth vertically and to back-and-forth horizontally. Vertical and horizontal, for purposes of this disclosure, are with reference to ground and a general orientation of the vehicle 10 during operation.

To further facilitate alignment of the first electrical contact 66 relative to the second electrical contact 70, the first aperture 78 of the first electrical contact 66 is oval-shaped. In another example, the first aperture 78 of the first electrical contact 66 is oversized relative to the second aperture 82 of the second electrical contact 70. This oval-shape and/or oversizing can enable the fastener 74 to move within the first aperture 78 of the first electrical contact 66 during the securing. In another example, the second aperture 82 in the second electrical contact 70 could instead or additionally be oval-shaped, oversized, or both.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A electrical connection system, comprising:
a first electrical contact; and
a second electrical contact joined directly to the first electrical contact, the first electrical contact configured to flex relative to the second electrical contact along a first axis, and configured to flex relative to the first electrical contact along a second axis.

2. The electrical connection system of claim 1, wherein the first electrical contact is a first busbar electrically connected to first battery terminal of a first battery, and the second electrical contact is a second busbar electrically connected to a second battery terminal of a different, second battery.

3. The electrical connection system of claim 2, wherein the first battery is within a first cell stack and the second battery is within a different, second cell stack.

4. The electrical connection system of claim 2, wherein a portion of the first battery terminal is disposed within a case of the first battery, and a portion of the second battery terminal is disposed within a case of the second battery.

5. The electrical connection system of claim 1, wherein the first electrical contact includes more bends than the second electrical contact.

6. The electrical connection system of claim 5, wherein the first electrical contact includes a plurality of bends, and the second electrical contact includes no more than one bend.

7. The electrical connection system of claim 1, further comprising a mechanical fastener that joins the second electrical contact directly to the first electrical contact, wherein the mechanical fastener is received within both a first aperture of the first electrical contact and within a second aperture of the second electrical contact.

8. The electrical connection system of claim 7, wherein at least one of the first aperture or the second aperture is oval-shaped.

9. The electrical connection system of claim 1, wherein the first electrical contact and the second electrical contact are within a traction battery pack.

10. The electrical connection system of claim 1, wherein the first electrical contact is flexible relative to the second electrical contact.

11. The electrical connection system of claim 1, wherein the second electrical contact is rigid relative to the first electrical contact.

12. The electrical connection system of claim 1, wherein the first electrical contact is a flexible first electrical contact, and the second electrical contact is a rigid second electrical contact.

13. The electrical connection system of claim 1, wherein the first electrical contact is configured to flex back-and-forth vertically and to flex back-and-forth horizontally.

14. The electrical connection system of claim 1, wherein the first electrical contact is a first busbar, and the second electrical contact is a second busbar.

15. A method of electrically connecting components, comprising:
joining a first electrical contact to a second electrical contact; and
flexing at least one of the first electrical contact or the second electrical contact during the joining.

16. The method of claim 15, further comprising joining the first electrical contact to the second electrical contact with a mechanical fastener.

17. The method of claim 15, wherein the flexing includes flexing vertically and flexing horizontally.

18. The method of claim 15, wherein the first electrical contact is flexible relative to the second electrical contact.

19. The method of claim 15, wherein the first electrical contact is a first busbar joined directly to a first terminal of a first battery, and the second electrical contact is a second busbar joined directly to a second terminal of a second battery.

20. The method of claim 19, wherein the first battery is within a first cell stack of a traction battery pack, and the second battery is within a second cell stack of the traction battery pack.
